(19) United States
(12) Patent Application Publication
(10) Pub. No.: US 2009/0056899 A1
(43) Pub. Date: Mar. 5, 2009

(54) BELT FOR A MACHINE FOR THE PRODUCTION OF WEB MATERIAL, SPECIFICALLY PAPER OR CARDBOARD

(76) Inventors: Martin Ringer, Bury (GB); David Ponton, Blackburn (GB); Tiny Willems, Overloon (NL); Marc Begin, Raleigh, NC (US); Emma Brown, Eagley (GB); Antony Morton, Ben Rhydding (GB)

Correspondence Address: TAYLOR & AUST, P.C., P.O. Box 560, 142. S Main Street, Avilla, IN, 46710, US

(21) Appl. No.: 12/169,021

(22) Filed: Jul. 8, 2008

(30) Foreign Application Priority Data
Sep. 5, 2007 (DE) 10 2007 042 201.8

(51) Int. Cl. B65G 15/32; D21F 9/00; D21F 7/08; D21F 3/02; B65G 15/30

(52) U.S. Cl. 162/280; 198/844.1; 162/232; 162/415; 162/375

(57) ABSTRACT

The invention relates to a belt for a machine for the production of web material, especially paper or cardboard, including a carrying structure and a pattern of wear-resistant material on at least one side of the carrying structure. The invention further relates to a machine for the production of a fibrous web in which the inventive belt is utilized.

### BACKGROUND OF THE INVENTION

1. Field of the Invention

The current invention relates to a belt for a machine for the production of web material, specifically paper or cardboard.

2. Description of the Related Art

Belts of this type are used in the form of endless belts in various sections of machinery for the production of web material, for example paper machines, in order to transport or process the web material which is to be produced through these processing stages. Especially because of the high rate of motion, because of the interaction of such belts with rolls which guide, drive or divert such belts and, because of speed differentials between the belts and structural components or materials which are in contact with said belts, high stress occurs, leading to significant wear and tear or abrasion. Also the continuously occurring bending strengths and the pressure loads which occur in the press nips lead to a significant wear, as do the high pressure liquid showers which are used in the cleaning section.

What is needed in the art is a belt for a machine for the production of web material, especially paper or cardboard, which, under consideration of the occurring loads provides improved wear-resistant characteristics.

### SUMMARY OF THE INVENTION

The present invention provides a belt for a machine for the production of web material, especially paper or cardboard, which includes a carrying structure and a pattern of wear-resistant material on at least one side of said carrying structure.

By applying a pattern of wear-resistant material the surface of such a belt is protected from excessive wear or abrasion, while at the same time maintaining basic characteristics, for example permeability for liquid or the ability to absorb and to direct liquid away from the web material which is to be produced.

In order to optimize the wear characteristics it is further suggested that the pattern of the wear-resistant material is formed by material sections composed of different component materials, preferably two different component materials.

Since such belts are generally subjected to high stresses on both sides—that is on the side which is in contact with the web material which is to be manufactured, as well as the machine side which is in contact with various machinery components—which can lead to excessive wear and tear, it is further suggested that a pattern of wear-resistant material is provided on both sides respectively of the carrying structure.

In order to produce a solid bond between the wear-resistant material and the carrying structure it is suggested that the wear-resistant material penetrates into the carrying structure at least partially.

In order to further improve the wear resistance of the inventive belt the wear-resistant material is preferably harder than the material of the carrying structure.

The wear-resistant material may include polymer material, for example polyurethane material, silicone material and/or epoxy resin material. Especially if the pattern of wear resistant fabric is formed by sections of different component materials, many different combinations of such component materials may be used.

The desired wear resistance can be achieved especially advantageously if the wear-resistant material has a viscosity in the range of 30,000 to 350,000 cP and/or if the wear-resistant material has a hardness in the range of Shore A 80 to Shore D 70, preferably approximately Shore D 55.

The wear-resistant material can be applied for example through printing or extrusion.

The carrying structure can be selected to be adapted in greatly varying ways to the particular application purpose, for example as transport belt, as press felt or in a dryer section. The composition of the carrying structure can, for example be composed of a woven, non-woven, felt or membrane type structure.

The pattern of wear-resistant material protrudes preferably on at least one side of the carrying structure by between 0.01 mm to 30 mm, especially between 1.0 mm and 15 mm beyond the carrying structure, whereby the at least one side is the side which if used as designated, can be brought into contact with the material web.

An additional embodiment of the invention provides that the pattern of wear-resistant material protrudes between 0.01 mm and 30 mm, especially between 1.0 mm and 15 mm beyond the carrying structure on both sides of the carrying structure.

A second aspect of the invention relates to a machine for the production of a fibrous web, especially a tissue web with a rotating cylinder on which the fibrous web is intermittently carried and a belt, as previously described, which is brought into contact with the fibrous web that is carried on the cylinder at a first transfer location, so that the fibrous web is transferred from the cylinder to the belt, whereby the belt and the cylinder have different speeds relative to each other at the first transfer location.

By utilizing the inventive belt in a machine for the production of a fibrous web, especially in a tissue machine in which the belt and a cylinder have a speed differential relative to each other at the transfer location of the fibrous web, the productivity and the reliability of such a machine in contrast to the use of conventional belts which are not equipped with wear-resistant material on at least one side of the carrying structure are clearly increased.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic sectional view of a belt for a machine for the production of web material;

FIG. 2 is view of an alternative arrangement of that depicted in FIG. 1;

FIGS. 3a) and b) depict different variation of a inventive belt with membrane-type structure;

FIG. 4 is a top view of the wear-resistant material pattern; and

FIG. 5 is a sectional view of a machine according to the invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

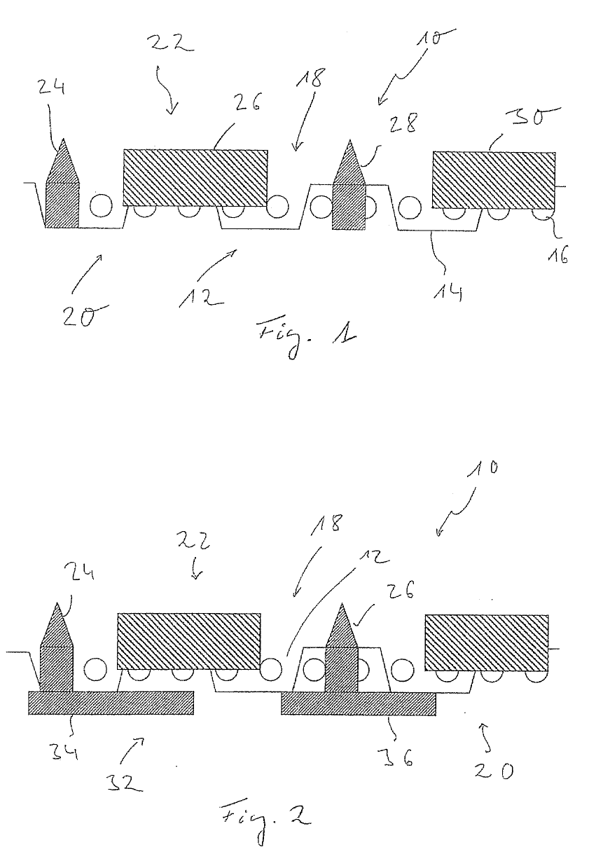

Referring now to the drawings, and more particularly to FIG. 1, there is shown a first example of a belt, generally identified with 10, for a machine for the production of web material, for example a paper machine. In this example the belt 10 consists of a woven type carrying structure 12 which is designed with a multitude of interwoven warp threads 14, and weft threads 16. It must be pointed out that, depending upon the design of the belt, the warp threads or the weft threads respectively may run in longitudinal or cross direction of the belt. In addition it is also self-evident that the symbolic depiction of these threads in FIG. 1 is merely an example and selection with regard to thickness, material and weave structure is not to be considered to be limited.

The top side 18 of the belt 10 or the carrying structure 12 in FIG. 1 is the side which during the production process comes into contact with the source material for the web material or with the web material itself, generally described as the paper side. The bottom side 20 in FIG. 1 is the side which comes into contact with various rollers driving and turning the belt 10—generally described as driven side. In the design variation for belt 10 depicted in FIG. 1, a pattern of wear-resistant material which is generally identified with 22 is provided on the paper side 18. This pattern 22 is formed by a multitude of material sections 24, 26, 28, 30. These material sections 24, 26, 28, 30 penetrate at least partially into the open, pore-type structure of the carrying structure 12, thereby surrounding the threads 14 and 16 in these areas. In this way a solid tie-in of the material sections 24, 26, 28, 30 with the carrying structure 12 is achieved. The choice of configuration of these material sections 24, 26, 28, 30 or in other words of the pattern 22 can be adapted to the specific requirements. The larger the surface area of the carrying structure 12 which is covered by the pattern 22, the more effectively it, or the belt 10 is protected against wear, the smaller however are the still open areas, and most of all the areas of the carrying structure 12 still effective for removal of liquid from the area of the web material that is to be produced.

It can further be seen in FIG. 1 that the pattern 22 may be composed not only from material sections 24, 26, 28, 30 with varying configuration, dimensioning or arrangement on the carrying structure 12, but also from different component materials. For example the material sections 24, 28 provided on the carrying structure 12 having the same shape or the same orientation on the one hand, and 26, 30 on the other hand can be constructed from the same component material respectively so that in the illustrated example the pattern 22 is basically constructed from two different component materials.

Especially heat-hardening, water-hardening or air-hardening polymer materials can be used as component materials. Polyurethane material, epoxy resin material or silicone material have been found to be especially suitable. Said material should have a viscosity in the range of 30,000 to 350,000 cP (centipoise) and a hardness in the range of Shore A 80 to Shore D 70, preferably Shore D55. In addition, the pattern 22 may be applied in one printing process, for example XYZ printing process. Even the utilization of a screening process, for example an extrusion process, especially a synchronous extrusion process is possible.

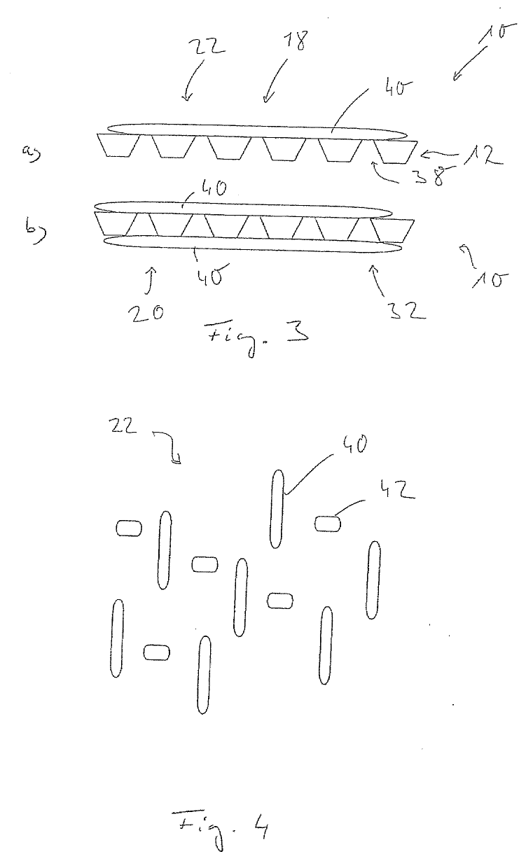

FIG. 2 illustrates one design form whereby such a pattern 22 of wear-resistant material is provided not only on the paper side 18 of the belt 10, but also a pattern 32 with a multitude of material sections 34, 36 is provided also on the driven side 20. In the existing example these material sections 34, 36 are located essentially on the surface of the carrying structure 12 and may be connected with, or even consist of the same material as the material sections 24, 26 which form part of the pattern 22 on the paper side. It must be pointed out that also the pattern 32 can be composed from material sections consisting of different component materials, as can be seen basically in the example of the pattern 22.

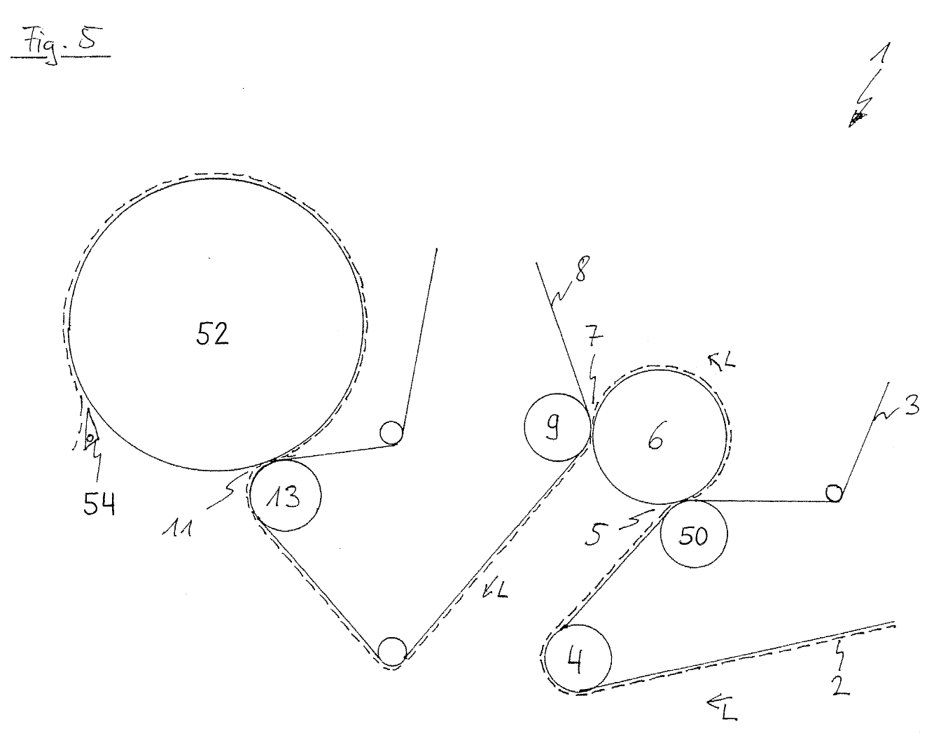

An additional variation of a belt 10 of this type is shown in FIGS. 3a) and 3b). This is a symbolic depiction of a carrying structure 12 which is a membrane type structure and provides for example, a multitude of small outlet openings 38 to discharge liquid from the area of the web material which is to be produced. In the example shown in FIG. 3a) a pattern 22 is provided only on the paper side 18 of the membrane-type carrying structure, while a pattern 32 is also provided on the driven side 20 in the variation depicted in FIG. 3b). An example of a pattern of this type is illustrated in FIG. 4. Different material sections 40, 42 are visible which differ with regard to shape and orientation and which, due to repetition provide an essentially periodic pattern 22 or possibly also 32 on the carrying structure 12. At the locations where these material sections 40, 42 are applied on the membrane-type carrying structure 12, they overlap the openings 38 and partially penetrate these, in order to also achieve a solid connection with the carrying structure 12 in these areas. In as far as a pattern 22 or 32 is to be provided on both sides 18, 20, said patterns may of course be the same and also consist of the same component material. Since generally however, different requirements exist and different demands occur on the paper side 18 versus the driven side 20 it can be advantageous to select different patters with different surface coverage share and also different component materials for the belt side 20 and the paper side 18.

By applying such patterns of wear-resistant material, a belt 10 as used for example in an endless configuration in a paper machine can be protected from the stresses which occur during operation and which promote wear. Especially pressure loads occurring in press nips, the bending loads and the abrasive forces occurring due to speed differences can be absorbed well by the pattern or patterns of wear-resistant materials so that the serviceable life of a belt constructed in this manner can be clearly extended. Arrangements can of course be selected for belts being utilized in very different sections of machinery for the production of web material, for example in paper machines. Depending upon the requirements of the specific application a suitable composition may also be selected for example, for the carrying structure which may for example be composed in a woven, non-woven, felt or, as described membrane-type configuration.

FIG. 5 shows a section of a web 2 producing, especially a tissue web producing machine 1. Illustrated is the section after the tissue web 2 was produced in a forming section which is not shown.

Viewed in direction of web travel L the formed tissue web 2 is initially carried on a press belt which is configured for example as a press felt 3 around a turning roller which is configured for example as a suction turning roller 4, before said tissue web 2 is transferred at a second transfer location 5 from the press belt 3 to a cylinder 6 and is carried on the shell surface of the cylinder. In the present example cylinder 6 is heated.

At the second transfer location 5 the web 2 is run through a press nip which is formed between the cylinder 6 and a counter press element 50 which, for example, can be in the embodiment of a shoe press roller or a conventional press roller.

In accordance with the current invention a belt 8 is brought into contact with the web 2 which is carried on the cylinder 6 at a first transfer location 7, so that the web 2 is transferred from the cylinder 6 to the belt 8, whereby the belt 8 and the cylinder 6 have a speed differential to each other at the first transfer location 7. In actual fact, the belt 8 runs slower at the first transfer location than the cylinder 6.

The speed difference between the belt 8 and the cylinder 6 at the first transfer location 5 is approximately 5%-50%, especially approximately 10%-30%.

During and/or after the transfer of the fibrous web 2 from the cylinder 6 to the belt 8, said fibrous web 2 is either compressed or creped.

The belt 8 in this instance is consistent with a belt as illustrated in FIGS. 1 through 4. In the present example the pattern of wear-resistant material is provided at least on that side of the carrying structure of the belt on which the fibrous web 2 is carried.

At the first transfer location the belt 8 wraps around a roll 9 in such a way that—at the first transfer location 7—the belt 8 is pressed against the cylinder 6 by the roll 9, especially with a pressure of 10-40 bar.

Following the first transfer location 7 when viewed in direction of web travel, a third transfer location 11 is provided at which the fibrous web 2 is transferred from the belt 8 to a dryer cylinder, especially a Yankee-dryer cylinder 52.

At the third transfer location 11 the fibrous web 2 is run through a press nip which is formed between the dryer cylinder 52 and counter press element 13 which, for example, can be in the embodiment of a shoe press roller or a conventional press roller. After the third transfer location 11 the fibrous web 2 is carried on the shell surface of the Yankee-dryer cylinder 52 and is subsequently creped by way of a doctor blade 54.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A belt for a machine for producing a web of fibrous material, said belt comprising:
a carrying structure including at least one side; and
a pattern of a wear-resistant material on at least one said side of said carrying structure.

2. The belt in accordance with claim 1, wherein said pattern of said wear-resistant material includes a plurality of material sections composed of a plurality of different component materials.

3. The belt in accordance with claim 2, wherein said plurality of different component materials is two different component materials.

4. The belt in accordance with claim 1, wherein said carrying structure includes two sides, said pattern of said wear-resistant material being on both said sides respectively of said carrying structure.

5. The belt in accordance with claim 1, wherein said wear-resistant material penetrates at least partially into said carrying structure.

6. The belt in accordance with claim 1, wherein said wear-resistant material is harder than a material of said carrying structure.

7. The belt in accordance with claim 1, wherein said wear-resistant material includes a polymer material.

8. The belt in accordance with claim 7, wherein said wear-resistant material includes a polyurethane material.

9. The belt in accordance with claim 7, wherein said wear-resistant material includes a silicone material.

10. The belt in accordance with claim 7, wherein said wear-resistant material includes an epoxy-resin material.

11. The belt in accordance with claim 1, wherein said wear-resistant material has a viscosity in a range of 30,000 to 350,000 cP.

12. The belt in accordance with claim 1, wherein said wear-resistant material has a hardness in a range of Shore A 80 to Shore D 70.

13. The belt in accordance with claim 1, wherein said wear-resistant material has a hardness of approximately Shore D 55.

14. The belt in accordance with claim 1, wherein said wear-resistant material is applied by one of printing and extrusion.

15. The belt in accordance with claim 1, wherein said carrying structure is one of a woven felt, a non-woven felt, and a membrane type structure.

16. The belt in accordance with claim 1, wherein said pattern of said wear-resistant material protrudes on at least one said side of said carrying structure by between 0.01 mm to 30 mm beyond said carrying structure.

17. The belt in accordance with claim 16, wherein said carrying structure includes two sides, said pattern of said wear-resistant material protruding beyond said carrying structure on both said sides of said carrying structure.

18. The belt in accordance with claim 1, wherein said pattern of said wear-resistant material protrudes on at least one said side of said carrying structure by between 1.0 mm and 15 mm beyond said carrying structure.

19. A machine for producing a web of fibrous material, said machine comprising:
a rotating cylinder configured for intermittently carrying the web thereon; and
a belt including a carrying structure and a pattern of a wear-resistant material, said carrying structure including at least one side, said pattern of said wear-resistant material being on at least one said side of said carrying structure, said belt being brought into contact with the web that is carried on said rotating cylinder at a first transfer location so that the web is transferred from said rotating cylinder to said belt, said belt and said rotating cylinder having different speeds relative to each other at said first transfer location.

20. The machine in accordance with claim 19, wherein the web is one of compressed and creped at least one of during and after the web is transferred from said rotating cylinder to said belt.

21. The machine in accordance with claim 20, wherein said pattern of said wear-resistant material is provided on at least one said side of said carrying structure of said belt on which the web is carried.

22. The machine in accordance with claim 19, wherein said belt runs slower than said cylinder at said first transfer location.

23. The machine in accordance with claim 19, wherein said rotating cylinder is a heated rotating cylinder.

24. The machine in accordance with claim 19, further comprising a roll, said belt wrapping at least partly around said roll at said first transfer location.

25. The machine in accordance with claim 24, wherein said belt is pressed against said rotating cylinder by said roll at said first transfer location.

26. The machine in accordance with claim 24, wherein said belt is pressed against said rotating cylinder by said roll at said first transfer location at a pressure of 10-40 bar.

27. The machine in accordance with claim 19, further comprising a press belt, wherein, when viewed in a direction of travel of the web, a second transfer location is provided prior to said first transfer location, said second transfer location being that at which the web is transferred by said press belt onto said rotating cylinder.

28. The machine in accordance with claim 27, wherein said press belt is a press felt.

29. The machine in accordance with claim 27, wherein the machine defines a press nip at said second transfer location, the web being run through said press nip at said second transfer location.

30. The machine in accordance with claim 27, further comprising a dryer cylinder, wherein, when viewed in said direction of travel of the web, a third transfer location is provided following said first transfer location, said third transfer location being that at which the web is transferred from said belt to said dryer cylinder.

31. The machine in accordance with claim 27, wherein said dryer cylinder is a Yankee-dryer cylinder.

32. The machine in accordance with claim 27, further comprising a first forming wire, the web being formed on said first forming wire and being subsequently transferred to said press belt.

33. The machine in accordance with claim 19, wherein a speed difference between said belt and said rotating cylinder at said first transfer location is approximately 5%-50%.

34. The machine in accordance with claim 19, wherein a speed difference between said belt and said rotating cylinder at said first transfer location is approximately 10%-30%.
